(19) United States
(12) Patent Application Publication
(10) Pub. No.: US 2023/0347908 A1
(43) Pub. Date: Nov. 2, 2023

(54) METHOD AND DEVICE FOR PROVIDING INTERFACE FOR MANAGING A VEHICLE OPERATING CORPORATION AND INTERFACE FOR MANAGING DRIVER BELONGING TO VEHICLE OPERATING CORPORATION

(71) Applicant: 42DOT INC., Seoul (KR)

(72) Inventors: Hyun Seok KIM, Seongnam (KR); Min Cheol KIM, Seoul (KR); SE IL JEONG, Seoul (KR)

(21) Appl. No.: 18/307,897

(22) Filed: Apr. 27, 2023

(30) Foreign Application Priority Data
Apr. 29, 2022 (KR) 10-2022-0053866

(51) Int. Cl. B60W 40/09; B60W 50/14

(52) U.S. Cl. CPC B60W 40/09; B60W 50/14; B60W 2050/146

(57) ABSTRACT

Provided are a method and device for providing an interface for managing a vehicle operating corporation and an interface for managing an affiliated driver belonging to a vehicle operating corporation. The method of providing an interface for managing a vehicle operating corporation includes displaying a first corporation management interface including a 1-1st area configured to list data about one or more registered corporations, a 1-2nd area configured to set conditions for the one or more registered corporations to be listed in the 1-1st area, and a 1-3rd area configured to add data about a registered corporation to a database, in response to receiving an input for interacting with an object included in the 1-2nd area to set corporation listing conditions, selecting data about one or more registered corporations that satisfy the corporation listing conditions, from among data about a plurality of registered corporations, and displaying the selected data about the one or more registered corporations to be listed in the 1-1st area, and in response to receiving an input for interacting with an object included in the 1-3rd area, displaying a second corporation management interface for adding a registered corporation to the database.

### CROSS-REFERENCE TO RELATED APPLICATION

This application is based on and claims priority under 35 U.S.C. § 119 to Korean Patent Application No. 10-2022-0053866, filed on Apr. 29, 2022, in the Korean Intellectual Property Office, the disclosure of which is incorporated by reference herein in its entirety.

### BACKGROUND

### 1. Field

The present disclosure relates to methods and devices for providing an interface for managing a vehicle operating corporation and an interface for managing a driver belonging to a vehicle operating corporation.

### 2. Description of the Related Art

Conventional transportation vehicles include buses, subways, taxis, and the like, and buses and subways charge inexpensive fares but have the inconvenience of having to go to a designated area at a designated time, whereas taxis allow passengers to get on and off wherever they want, but charge expensive fares.

In general cities, it is possible to freely use transportation vehicles such as buses, subways, or taxis, however, in remote areas such as rural areas, accessibility to conventional transportation vehicles is poor because, for example, no taxis are operating or buses travel their routes only 3 or 4 times a day in such areas.

Demand-responsive transportation (DRT) is emerging as a transportation method that has the advantages of the conventional transportation vehicles and remedies the disadvantages. The demand-responsive transportation refers to a transportation method of flexibly managing operation sections, operation frequencies, operation times, and the like without fixed lines, according to passenger demand.

Recently, research on a method of more efficiently operating a demand-responsive transportation system is required.

The related art described above is technical information that the inventor(s) of the present disclosure has achieved to derive the present disclosure or has achieved during the derivation of the present disclosure, and thus, it cannot be considered that the related art has been published to the public before the filing of the present disclosure.

### SUMMARY

Provided are methods and devices for providing an interface for managing a vehicle operating corporation and an interface for managing a driver belonging to a vehicle operating corporation. Technical objectives of the present disclosure are not limited to the foregoing, and other unmentioned objects or advantages of the present disclosure would be understood from the following description and be more clearly understood from the embodiments of the present disclosure. In addition, it would be appreciated that the objectives and advantages of the present disclosure can be implemented by means provided in the claims and a combination thereof.

Additional aspects will be set forth in part in the description which follows and, in part, will be apparent from the description, or may be learned by practice of the presented embodiments of the disclosure.

A first aspect of the present disclosure may provide a method of providing an interface for managing a vehicle operating corporation, the method including displaying a first corporation management interface including a 1-1 st area configured to list data about one or more registered corporations, a 1-2nd area configured to set conditions for the one or more registered corporations to be listed in the 1-1st area, and a 1-3rd area configured to add data about a registered corporation to a database, in response to receiving an input for interacting with an object included in the 1-2nd area to set corporation listing conditions, selecting data about one or more registered corporations that satisfy the corporation listing conditions, from among data about a plurality of registered corporations, and displaying the selected data about the one or more registered corporations to be listed in the 1-1st area, and in response to receiving an input for interacting with an object included in the 1-3rd area, displaying a second corporation management interface for adding a registered corporation to the database.

A second aspect of the present disclosure may provide a method of providing an interface for managing an affiliated driver belonging to a vehicle operating corporation, the method including displaying a first driver management interface including a 3-1st area configured to list data about one or more affiliated drivers belonging to a corporation, a 3-2nd area configured to set conditions for the one or more affiliated drivers to be listed in the 3-1st area, and a 3-3rd area configured to add data about an affiliated driver to a database, in response to receiving an input for interacting with an object included in the 3-2nd area to set driver listing conditions, selecting data about one or more affiliated drivers who satisfy the driver listing conditions, from among data about a plurality of affiliated drivers, and displaying the selected data about the one or more affiliated drivers to be listed in the 3-1st area, and in response to receiving an input for interacting with an object included in the 3-3rd area, displaying a second driver management interface for adding an affiliated driver to the database.

A third aspect of the present disclosure may provide a device for providing an interface for managing a vehicle operating corporation, the device including a memory storing at least one program, and a processor configured to execute the at least one program to display a first corporation management interface including a 1-1st area configured to list data about one or more registered corporations, a 1-2nd area configured to set conditions for the one or more registered corporations to be listed in the 1-1st area, and a 1-3rd area configured to add data about a registered corporation to a database, in response to receiving an input for interacting with an object included in the 1-2nd area to set corporation listing conditions, select data about one or more registered corporations that satisfy the corporation listing conditions, from among data about a plurality of registered corporations, and display the selected data about the one or more registered corporations to be listed in the 1-1st area, and in response to receiving an input for interacting with an object included in the 1-3rd area, display a second corporation management interface for adding a registered corporation to the database.

A fourth aspect of the present disclosure may provide a device for providing an interface for managing an affiliated driver belonging to a vehicle operating corporation, the device including a memory storing at least one program, and a processor configured to execute the at least one program to display a first driver management interface including a 3-1 st area configured to list data about one or more affiliated drivers belonging to a corporation, a 3-2nd area configured to set conditions for the one or more affiliated drivers to be listed in the 3-1st area, and a 3-3rd area configured to add data about an affiliated driver to a database, in response to receiving an input for interacting with an object included in the 3-2nd area to set driver listing conditions, select data about one or more affiliated drivers who satisfy the driver listing conditions, from among data about a plurality of affiliated drivers, and display the selected data about the one or more affiliated drivers to be listed in the 3-1st area, and in response to receiving an input for interacting with an object included in the 3-3rd area, display a second driver management interface for adding an affiliated driver to the database.

A fifth aspect of the present disclosure may provide a computer-readable recording medium having recorded thereon program for causing a computer to execute the method of the first or second aspect.

In addition, other methods and devices for implementing the present disclosure, and a computer-readable recording medium having recorded thereon a program for executing the method may be further provided.

Other aspects, features, and advantages other than those described above will be apparent from the following drawings, claims, and detailed description.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing an autonomous driving method according to an embodiment;

FIG. 2 is a block diagram illustrating hardware units included in an autonomous driving device according to an embodiment;

FIG. 3 is a diagram for describing a demand-responsive transportation system according to an embodiment;

FIG. 4 is an exemplary diagram for describing a control function performed by a control server according to an embodiment;

FIG. 5 is an exemplary diagram for describing a first corporation management interface according to an embodiment;

FIG. 6 is an exemplary diagram for describing a second corporation management interface according to an embodiment;

FIG. 7 is an exemplary diagram for describing a third corporation management interface according to an embodiment;

FIG. 8 is an exemplary diagram for describing a first driver management interface according to an embodiment;

FIG. 9 is an exemplary diagram for describing a second driver management interface according to an embodiment;

FIG. 10 is an exemplary diagram for describing a third driver management interface according to an embodiment;

FIG. 11 is a flowchart of a method of providing an interface for managing a vehicle operating corporation according to an embodiment;

FIG. 12 is a flowchart of a method of providing an interface for managing an affiliated driver belonging to a vehicle operating corporation according to an embodiment; and

FIG. 13 is a block diagram of an interface providing device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Advantages and features of the present disclosure and a method for achieving them will be apparent with reference to embodiments of the present disclosure described below together with the attached drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used herein are for describing particular embodiments and are not intended to limit the scope of the present disclosure. A singular expression may include a plural expression unless they are definitely different in a context. As used herein, terms such as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

Some embodiments of the present disclosure may be represented by functional block components and various processing operations. Some or all of the functional blocks may be implemented by any number of hardware and/or software elements that perform particular functions. For example, the functional blocks of the present disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. Furthermore, the present disclosure may employ known technologies for electronic settings, signal processing, and/or data processing. Terms such as “mechanism”, “element”, “unit”, or “component” are used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

Hereinafter, the term ‘vehicle’ may refer to all types of transportation instruments with engines that are used to move passengers or goods, such as cars, buses, motorcycles, kick scooters, or trucks.

Hereinafter, the present disclosure will be described in detail with reference to the accompanying drawings.

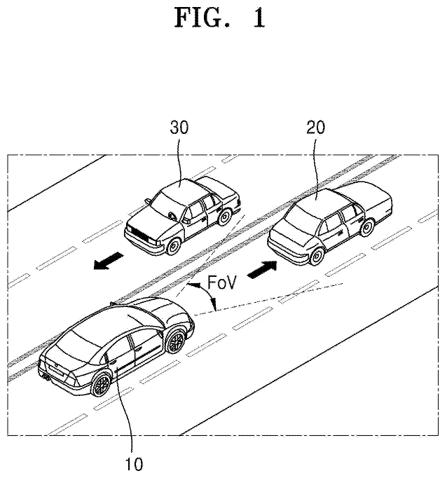

FIG. 1 is a diagram for describing an autonomous driving method according to an embodiment.

Referring to FIG. 1, an autonomous driving apparatus according to an embodiment of the present disclosure may be mounted on a vehicle to implement an autonomous vehicle 10. The autonomous driving apparatus mounted on the autonomous vehicle 10 may include various sensors configured to collect situational information around the autonomous vehicle 10. For example, the autonomous driving apparatus may detect a movement of a preceding vehicle 20 traveling in front of the autonomous vehicle 10, through an image sensor and/or an event sensor mounted on the front side of the autonomous vehicle 10. The autonomous driving apparatus may further include sensors configured to detect, in addition to the preceding vehicle 20 traveling in front of the autonomous vehicle 10, another traveling vehicle 30 traveling in an adjacent lane, and pedestrians around the autonomous vehicle 10.

At least one of the sensors configured to collect the situational information around the autonomous vehicle may have a certain field of view (FoV) as illustrated in FIG. 1. For example, in a case in which a sensor mounted on the front side of the autonomous vehicle 10 has a FoV as illustrated in FIG. 1, information detected from the center of the sensor may have a relatively high importance. This may be because most of information corresponding to the movement of the preceding vehicle 20 is included in the information detected from the center of the sensor.

The autonomous driving apparatus may control the movement of the autonomous vehicle 10 by processing information collected by the sensors of the autonomous vehicle 10 in real time, while storing, in a memory device, at least part of the information collected by the sensors.

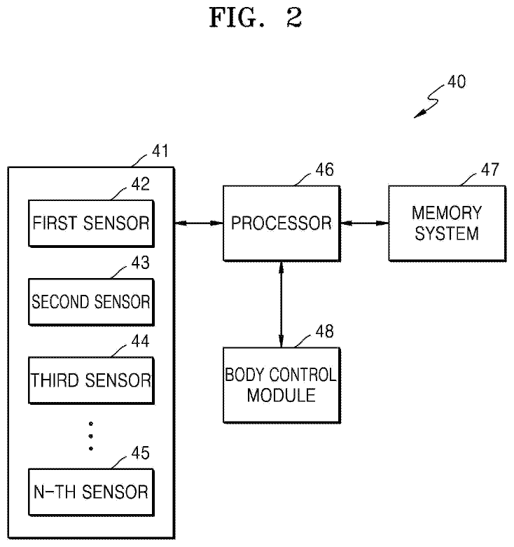

FIG. 2 is a block diagram illustrating hardware units included in an autonomous driving device according to an embodiment.

Referring to FIG. 2, an autonomous driving apparatus 40 may include a sensor unit 41, a processor 46, a memory system 47, a body control module 48, and the like. The sensor unit 41 may include a plurality of sensors 42 to 45, and the plurality of sensors 42 to 45 may include an image sensor, an event sensor, an illuminance sensor, a global positioning system (GPS) device, an acceleration sensor, and the like.

Data collected by the sensors 42 to 45 may be delivered to the processor 46. The processor 46 may store, in the memory system 47, the data collected by the sensors 42 to 45, and control the body control module 48 based on the data collected by the sensors 42 to 45 to determine the movement of the vehicle. The memory system 47 may include two or more memory devices and a system controller configured to control the memory devices. Each of the memory devices may be provided as a single semiconductor chip.

In addition to the system controller of the memory system 47, each of the memory devices included in the memory system 47 may include a memory controller, which may include an artificial intelligence (AI) computation circuit such as a neural network. The memory controller may generate computational data by applying certain weights to data received from the sensors 42 to 45 or the processor 46, and store the computational data in a memory chip.

The autonomous driving device 40 may be mounted on a demand-responsive vehicle to be described below.

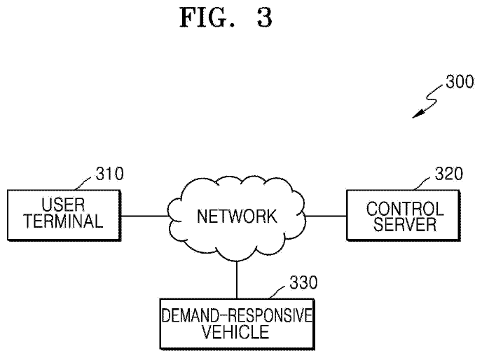

FIG. 3 is a diagram for describing a demand-responsive transportation system according to an embodiment.

The demand-responsive transportation (DRT) refers to a transportation method of flexibly managing operation sections, operation frequencies, operation times, and the like without fixed lines, according to passenger demand.

The demand-responsive transportation may be classified into various types according to a line operation method. For example, a fixed-line type refers to a type in which all of operation times, stops, and starting points and end points of lines are fixed. An off-route type refers to a type in which operation times and starting points and end points of lines are fixed, but a new stop may be set according to reservation by a user, in addition to fixed stops. A quasi-dynamic type refers to a type in which starting points and end points of lines are fixed, but only departure and arrival times among operation times are fixed, and stops other than the starting points and end points of the lines may be freely set. A dynamic type refers to a type in which all of operation times, stops, and starting points and end points of lines are not fixed.

In addition, the demand-responsive transportation may be classified into various types according to the numbers of starting points and end points. For example, a one-to-one type refers to a type in which lines have difference starting points and different end points. In addition, a one-to-many type refers to a type in which lines have the same starting point and different end points, and a many-to-one type refers to a type in which lines have different starting points and the same end point. In addition, a many-to-many type refers to a type in which lines do not have particular starting points and end points, and may be changed according to circumstances or needs.

Referring to FIG. 3, a demand-responsive transportation system 300 may include a user terminal 310, a control server 320, and a demand-responsive vehicle 330.

The user terminal 310 may be, but is not limited to, a smart phone, a tablet personal computer (PC), a PC, a smart television (TV), a mobile phone, a personal digital assistant (PDA), a laptop computer, a media player, a microserver, a global positioning system (GPS) device, an electronic book terminal, and a digital broadcasting terminal, a navigation system, a kiosk, an MP3 player, a digital camera, a home appliance, a device equipped with a camera, or any one of other mobile or nonmobile computing devices. In addition, the user terminal 310 may be a wearable device having a communication function and a data processing function, such as a watch, glasses, a hair band, or a ring. However, the present disclosure is not limited thereto.

The control server 320 refers to a server that performs a control function for operating demand-responsive transportation. The demand-responsive vehicle 330 refers to a vehicle that is allocated according to passenger demand, and the operation section, operation frequency, operation times, and the like of which are determined according to the method of operating the demand-responsive transportation.

The user terminal 310, the control server 320, and the demand-responsive vehicle 330 may perform communication by using a network. For example, the network may include a local area network (LAN), a wide area network (WAN), a value-added network (VAN), a mobile radio communication network, a satellite communication network, and a combination thereof, may be a comprehensive data communication network that allows each network constituent entity illustrated in FIG. 3 to perform seamless communication with each other, and may include a wired Internet network, a wireless Internet network, and a mobile wireless communication network. In addition, the wireless communication may include, but is not limited to, a wireless LAN (e.g., Wi-Fi), Bluetooth, Bluetooth Low Energy, Zigbee, Wi-Fi Direct (WFD), ultra-wideband (UWB), Infrared Data Association (IrDA), and near-field communication (NFC).

The user terminal 310 may access the control server 320 through the network, and transmit, to the control server 320, information such as a departure time, a departure point, and a destination. The control server 320 may check information of the demand-responsive vehicle 330 registered therein to perform an allocation process. For example, the control server 320 may compare the departure point of the user terminal 310 with the current location of the demand-responsive vehicle 330, and allocate the demand-responsive vehicle 330 that may arrive at the departure point of the user terminal 310 fastest. The control server 320 may transmit allocation information to the user terminal 310 and the demand-responsive vehicle 330 through the network.

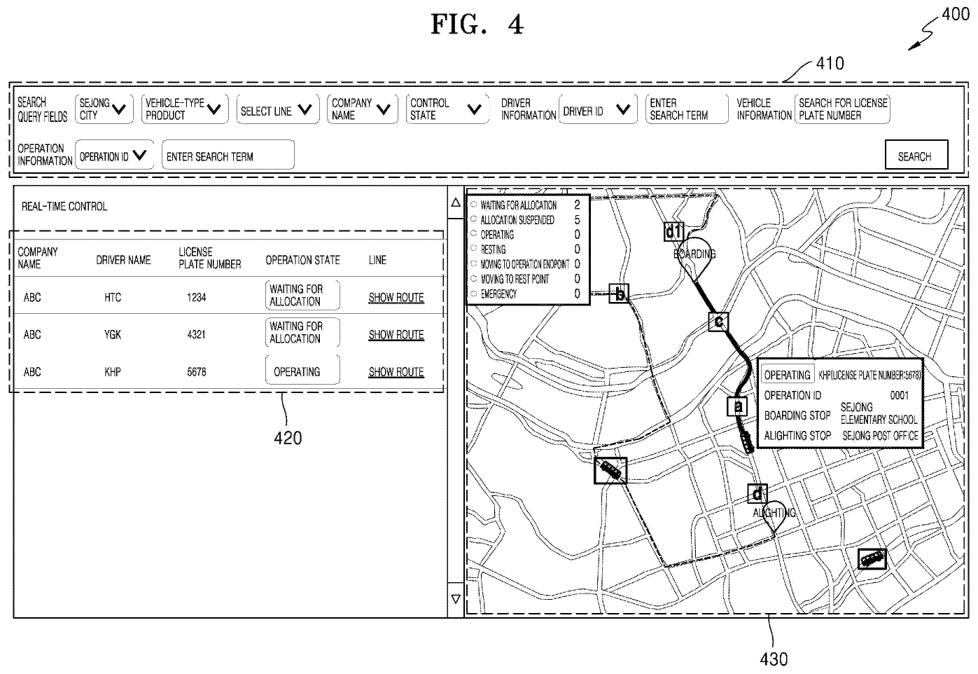

FIG. 4 is an exemplary diagram for describing a control function performed by a control server according to an embodiment.

The control server refers to a server capable of controlling a plurality of demand-responsive vehicles operated under control by a demand-responsive transportation system. Information about a plurality of companies providing a demand-responsive transportation service may be registered in the control server. In addition, information about a plurality of vehicles operated by each company and information about a plurality of drivers registered in each company may be registered in the control server.

FIG. 4 illustrates a user interface 400 provided to a manager by the control server. Referring to the user interface 400, the manager may set various conditions for searching for a demand-responsive vehicle by interacting with objects included in a 5-1st area 410. For example, by interacting with the objects included in the 5-1 st area 410, the manager may set conditions for an operation region, an operating company, a vehicle-type product, a line, and a control state. In addition, by interacting with the objects included in the 5-1st area 410, the manager may set conditions for driver information, vehicle information, and operation information.

In response to the manager setting the conditions for searching for a demand-responsive vehicle, the control server may display, in a 5-2nd area 420, detailed information about demand-responsive vehicles that satisfy the set conditions. Information about company names, driver names, license plate numbers, operation states, and lines of the demand-responsive vehicles that satisfy the set conditions may be displayed in the 5-2nd area 420, but the information displayed in the 5-2nd area 420 is not limited thereto. For example, in response to the manager setting conditions to specify the operation region as ‘Sejong City’ and the company name as ‘ABC’, the control server may display information about driver names, license plate numbers, control states, and lines of demand-responsive vehicles of company ‘ABC’ operating in ‘Sejong City’.

In addition, in response to the manager setting the conditions for searching for the demand-responsive vehicle, the control server may display, in a 5-3rd area 430, operation information about the demand-responsive vehicles that satisfy the set conditions. Information about the operation states (e.g., waiting for allocation, allocation suspended, operating, resting, etc.), moving paths, and current locations of the demand-responsive vehicles that satisfy the set conditions may be displayed in the 5-3rd area 430, but the information displayed in the 5-3rd area 430 is not limited thereto.

Meanwhile, the manager may select a certain demand-responsive vehicle by interacting with the objects included in the 5-2nd area 420. In response to the manager selecting a certain demand-responsive vehicle, the control server may display, in the 5-3rd area 430, a boarding point, an alighting point, and a remaining moving path of the selected demand-responsive vehicle. For example, in FIG. 4, a license plate number ‘5678’ is selected by the manager, and accordingly, the boarding point, alighting point, and remaining moving path of the license plate number ‘5678’ are displayed in the 5-3rd area 430.

The control server may store information about companies providing demand-responsive transportation services, information about a plurality of vehicles operated by each company, and information about a plurality of drivers registered in each company. In addition, the control server may improve the control accuracy and convenience of the manager by processing the stored information and providing the processed information in the form of a user interface to the manager using the control server.

Meanwhile, although it is described above with reference to FIG. 4, for convenience of description, that the 5-1st area 410, the 5-2nd area 420, and the 5-3rd area 430 are displayed in one interface, the areas may be displayed in different interfaces.

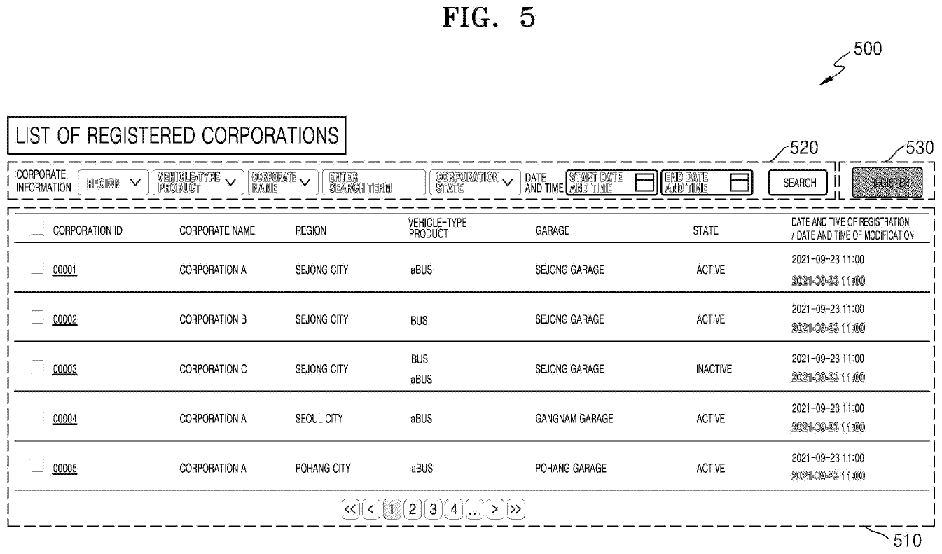

Hereinafter, an interface for managing a vehicle operating corporation and an interface for managing a driver belonging to a corporation according to the present disclosure will be described with reference to FIGS. 5 to 10.

Hereinafter, operations according to various embodiments may be understood to be performed by an interface providing device or a processor included in the interface providing device, and the interface providing device may refer to a control server, which may be the control server 320 described above or the control server described above with reference to FIG. 4.

Hereinafter, a database for storing data may be a component included in the interface providing device or a component configured separately from the interface providing device.

As described above, information about a plurality of companies (hereinafter, referred to as ‘vehicle operating corporations’ or ‘corporations’) providing demand-responsive transportation services may be registered in the control server. The control server may be configured to register a vehicle operating corporation and manage a plurality of vehicle operating corporations. Registering a vehicle operating corporation and managing a plurality of vehicle operating corporations may be performed through an interface for managing a vehicle operating corporation according to the present disclosure.

The interface for managing a vehicle operating corporation may be configured and provided to facilitate various functions and data processing for a user to register and manage a vehicle operating corporation for a demand-responsive transportation service.

In an embodiment, the interface for managing a vehicle operating corporation may be provided to a user terminal. In an embodiment, the user terminal may be the user terminal 310 described above.

The interface for managing a vehicle operating corporation that may be provided to the user terminal may include one or more interfaces.

In an embodiment, a user who wants to manage a vehicle operating corporation through the interface for managing a vehicle operating corporation may log in to obtain an access permission. In an embodiment, the processor may permit the access and display a first corporation management interface. The first corporation management interface may be an interface that the user first encounters after logging in, among one or more interfaces that may be included in the interface for managing a vehicle operating corporation, and may be configured to inquire or manage information about one or more corporations.

FIG. 5 is an exemplary diagram for describing a first corporation management interface according to an embodiment.

Referring to FIG. 5, a first corporation management interface 500 may include a 1-1st area 510, a 1-2nd area 520, and a 1-3rd area 530.

In an embodiment, the 1-1st area 510, which may be included in the first corporation management interface 500, may be configured to list data about one or more registered corporations that are registered to provide demand-responsive transportation services.

In an embodiment, the 1-1st area 510, may be configured as a list for checking various pieces of information about a registered corporation, such as a corporate identifier (ID), a corporate name, a region in which the corporation provides a demand-responsive transportation service, a vehicle-type product provided by the corporation, a garage location, an operational state, a date and time of registration of the corporation, a date and time of modification of corporate information, and the like. Although FIG. 5 illustrates that five registered corporations are listed in the 1-1st area 510, but the present disclosure is not limited thereto.

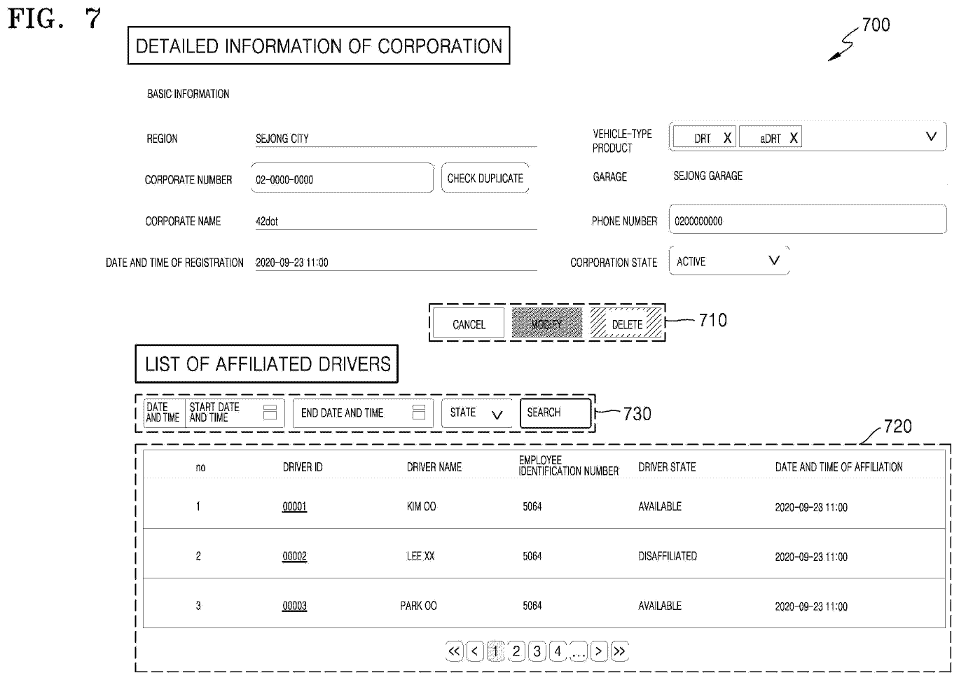

In an embodiment, the user using the first corporation management interface 500 may interact with an object indicating the corporation ID of a particular corporation among one or more corporations listed in the 1-1st area 510. In an embodiment, in response to receiving an input for interacting with an object indicating the corporation ID of a particular corporation, the processor may display a third corporation management interface. An embodiment of the third corporation management interface will be described in detail below with reference to FIG. 7.

In an embodiment, in a case in which one or more corporations are displayed in the 1-1st area 510, and the same corporation (the same corporate name) provides a demand-responsive transportation service in a plurality of regions, as illustrated in FIG. 5, the corporation may be regarded and displayed as separate corporations for the respective regions in which the demand-responsive transportation service is provided. In another embodiment, in a case in which one or more corporations are displayed in the 1-1st area 510, and the same corporation provides a demand-responsive transportation service in a plurality of regions, the corporation may be regarded as the same corporation and displayed as one corporation. In addition, various embodiments for displaying one or more corporations may be applied.

In an embodiment, the 1-2nd area 520, which may be included in the first corporation management interface 500, may be configured to set conditions for one or more registered corporations to be listed in the 1-1st area 510.

For example, the 1-2nd area 520 may be configured to set conditions such that the 1-1st area 510 displays only registered corporations providing demand-responsive transportation services in a particular region. For example, the 1-2nd area 520 may be configured to set conditions such that the 1-1st area 510 displays only registered corporations providing a particular vehicle-type product. In addition, the 1-2nd area 520 may be configured to have any suitable function such that the manager may selectively check information about a registered corporation.

In an embodiment, the 1-2nd area 520 may include an object with which the user may interact. For example, one or more objects included in the 1-2nd area 520 may be icons, drop-down buttons, dialog boxes, and the like for setting conditions.

In an embodiment, the user using the first corporation management interface 500 may interact with an object included in the 1-2nd area 520 to deliver an input for setting corporation listing conditions. In an embodiment, in response to receiving an input for setting corporation listing conditions, the processor may select data about at least one registered corporation that satisfies the corporation listing conditions, from among data about a plurality of registered corporations providing demand-responsive transportation services. In an embodiment, the processor may load data about one or more selected registered corporations, and display the data to be listed in the 1-1st area 510.

In an embodiment, in a case in which the user using the first corporation management interface 500 has not set conditions through the 1-2nd area 520, data about one or more registered corporations listed in the 1-1st area 510 may be data about all registered corporations.

In an embodiment, the 1-3rd area 530, which may be included in the first corporation management interface 500, may be configured to add data about a registered corporation to the database.

In other words, the user using the interface for managing a vehicle operating corporation may register a new corporation through the 1-3rd area 530.

In an embodiment, the 1-3rd area 530 may include an object with which the user may interact. For example, one or more objects included in the 1-3rd area 530 may be icons.

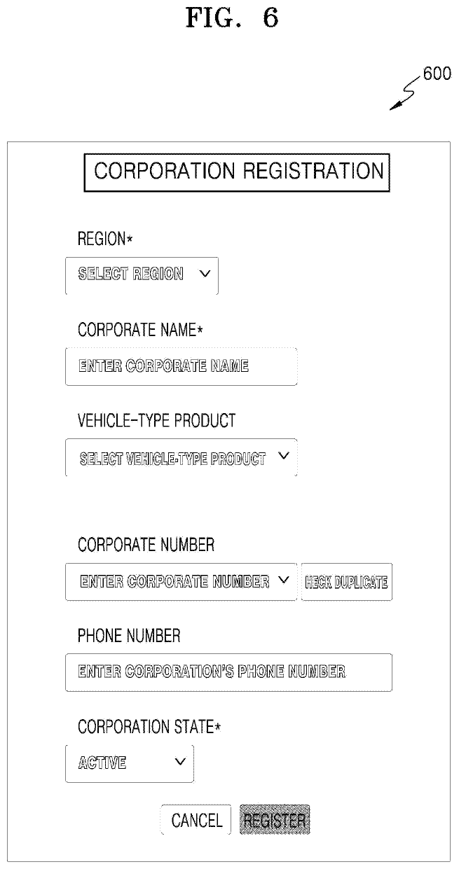

In an embodiment, the user using the interface for managing a vehicle operating corporation may interact with an object included in the 1-3rd area 530, and in response to receiving an input for interacting with the object included in the 1-3rd area 530, the processor may display a second corporation management interface. In the present disclosure, the second corporation management interface may refer to an interface configured to add a registered corporation to the database. An embodiment of the second corporation management interface will be described in detail below with reference to FIG. 6.

In an embodiment, the first corporation management interface 500 may further include a 1-4th area (not shown) configured to extract data about a registered corporation as a file.

In an embodiment, the user using the corporation management interface may interact with an object included in the 1-4th area, and in response to receiving an input for interacting with the object included in the 1-4th area, the processor may transmit data about one or more registered corporations as a file. In an embodiment, the data about the one or more registered corporations transmitted as the file may be data about corporations listed in the 1-1 st area 510. In an embodiment, the 1-4th area may further include an object configured to receive data about all registered corporations as a file, in addition to the corporations listed in the 1-1 st area 510.

In an embodiment, the user using the corporation management interface may store or extract the transmitted file, to a storage device.

As described above, in response to receiving an input for interacting with an object included in the 1-3rd area 530, the processor may display the second corporation management interface. The second corporation management interface may be configured to add a registered corporation to the database.

Meanwhile, although it is described above with reference to FIG. 5, for convenience of description, that the 1-1st area 510, the 1-2nd area 520, and the 1-3rd area 530 are displayed in one interface, and other areas or sub-interfaces are also displayed in one interface, the areas or sub-interfaces may be displayed in different interfaces.

FIG. 6 is an exemplary diagram for describing a second corporation management interface according to an embodiment.

Referring to FIG. 6, a second corporation management interface 600 may include an interface for inputting data about a registered corporation.

In an embodiment, the data about the registered corporation that may be input through the second corporation management interface 600 may include a corporate name, a region in which the corporation provides a demand-responsive transportation service (hereinafter, referred to as ‘operation provision region’), a vehicle-type product provided by the corporation, a corporate number, a phone number, and the like.

In an embodiment, an interface for inputting each data about a registered corporation may be suitably configured according to the type of the data about the registered corporation. For example, an interface for inputting a corporate name may be configured to receive a text input. For example, an interface for inputting a phone number may be configured to receive a number input.

In an embodiment, an interface for inputting an operation provision region may be configured to select a region in which a corporation to be registered intends to provide a demand-responsive transportation service, from among regions in which the demand-responsive transportation service may be provided. In an embodiment, for example, the user using the second corporation management interface 600 may be provided with a list of regions in which the demand-responsive transportation service may be provided, by interacting with an object (e.g., a drop-down button) included in the interface for inputting an operation provision region. In an embodiment, the user using the second corporation management interface 600 may input data about an operation provision region by selecting the operation provision region from the list of the regions in which the demand-responsive transportation service may be provided.

In a system for providing a demand-responsive transportation service of the present disclosure, providable vehicle-type products may depend on a region in which the demand-responsive transportation service is provided. For example, in a case in which the region in which the demand-responsive transportation service is provided is ‘Pohang City’, only a vehicle-type product ‘aBUS’ may be provided in ‘Pohang City’. For example, in a case in which the region in which the demand-responsive transportation service is provided is ‘Sejong City’, vehicle-type products ‘aBUS’ and ‘BUS’ may be provided in ‘Sejong City’.

In an embodiment, in response to receiving an input of an operation provision region, the processor may determine one or more vehicle-type products that may be provided in the input operation provision region. In an embodiment, the processor may display the determined one or more vehicle-type products, in the second corporation management interface 600. In an embodiment, the user using the second corporation management interface 600 may select any one of the displayed one or more vehicle-type products. Through this process, input of data about an irrelevant corporation may be prevented.

In an embodiment, the user using the second corporation management interface 600 may interact with a data input completion object that may be included in the second corporation management interface 600, to complete input of data about a corporation. In an embodiment, in a case in which minimum required data (e.g., corporate name) for corporation registration has not been input, even when the user interacts with the data input completion object, the input of the data about the corporation may not be completed. In an embodiment, in response to the user interacting with the data input completion object, the processor may store the input data in the database.

Meanwhile, although it is described above with reference to FIG. 6, for convenience of description, that areas or sub-interfaces are displayed in one interface, the areas or sub-interfaces may be displayed in different interfaces.

As described above, in an embodiment, in response to receiving an input for interacting with an object indicating a corporate ID of a particular corporation among one or more registered corporations listed in the 1-1 st area, the processor may display a third corporation management interface. In the present disclosure, the third corporation management interface may refer to an interface for checking detailed information about a particular corporation.

FIG. 7 is an exemplary diagram for describing a third corporation management interface according to an embodiment.

Referring to FIG. 7, a third corporation management interface 700 may include a 2-1 st area 710, a 2-2nd area 720, and a 2-3rd area 730.

In an embodiment, the third corporation management interface 700 may include an area in which detailed information about a particular corporation may be checked. The detailed information about the corporation may include, for example, a corporate name, an operation provision region, a vehicle-type product provided by the corporation, a corporate number, a phone number, a data and time of registration, a corporation state, and the like.

In an embodiment, the 2-1 st area 710 that may be included in the third corporation management interface 700 may be configured to modify or delete data about a particular corporation.

In an embodiment, the 2-1st area 710 may include an object with which the user may interact. In an embodiment, one or more objects included in the 2-1st area 710 may include an object for modifying data or an object for deleting data. In an embodiment, the user using the third corporation management interface 700 may interact with an object included in the 2-1 st area 710 and, in response to receiving the interaction with the object, the processor may display an interface for modifying data about a particular corporation or an interface for deleting data about a particular corporation.

In an embodiment, the user using the third corporation management interface 700 may input, through the displayed interface, a signal for modifying or deleting data about a particular corporation. In an embodiment, in response to an input of the user for modifying data, the processor may modify data about a particular corporation included in the database. In an embodiment, in response to an input of the user for deleting data, the processor may delete data about a particular corporation included in the database.

In an embodiment, the 2-2nd area 720 that may be included in the third corporation management interface 700 may be configured to list data about one or more affiliated drivers belonging to a particular corporation.

The 2-2nd area 720 may be configured as a list for checking various pieces of information about an affiliated driver, such as a driver ID, a driver name, an employee identification number, a driver state, a date and time of registration, a work region, and the like. Although FIG. 7 illustrates that three affiliated drivers are listed in the 2-2nd area 720, but the present disclosure is not limited thereto.

In an embodiment, the user using the third corporation management interface 700 may interact with an object indicating a driver ID of a particular affiliated driver among the one or more affiliated drivers listed in the 2-2nd area 720. In an embodiment, in response to receiving an input for interacting with an object indicating a driver ID of a particular affiliated driver, the processor may display an interface for checking detailed information about the affiliated driver.

In an embodiment, the 2-3rd area 730, which may be included in the third corporation management interface 700, may be configured to set conditions for one or more affiliated drivers to be listed in the 2-2nd area 720.

For example, the 2-3rd area 730 may be configured to set conditions such that the 2-2nd area 720 displays only affiliated drivers working in a particular work region. For example, the 2-3rd area 730 may be configured to set conditions such that only affiliated drivers registered in a particular time period are displayed.

In an embodiment, the 2-3rd area 730 may include an object with which the user may interact. For example, one or more objects included in the 2-3rd area 730 may be icons, drop-down buttons, dialog boxes, and the like for setting conditions.

In an embodiment, the user using the third corporation management interface 700 may interact with an object included in the 2-3rd area 730 to deliver an input for setting driver listing conditions. In an embodiment, in response to receiving the input for setting the driver listing conditions, the processor may select data about one or more affiliated drivers who satisfy the driver listing conditions, from among a plurality of affiliated drivers belonging to a corporation. In an embodiment, the processor may load the selected data and display the data to be listed in the 2-2nd area 720.

In an embodiment, in addition to the illustrated areas, the third corporation management interface 700 may further include a 2-4th area (not shown) or a 2-5th area (not shown).

In an embodiment, the 2-4th area may be configured to list data about one or more affiliated vehicles belonging to a particular corporation.

In an embodiment, the 2-4th area may be configured as a list for checking various pieces of information about a affiliated vehicle, such as a vehicle ID, a vehicle name, a license plate number, a line, a vehicle trim, a seat type, a state, a date and time of registration, and the like.

In an embodiment, the user using the third corporation management interface 700 may interact with an object indicating a vehicle ID of a particular vehicle among one or more vehicles listed in the 2-4th area. In an embodiment, in response to receiving an input for interacting with an object indicating a vehicle ID of a particular affiliated vehicle, the processor may display an interface for checking detailed information about the affiliated vehicle.

In an embodiment, the 2-5th area may be configured to set conditions for one or more affiliated vehicles to be listed in the 2-4th area.

For example, the 2-5th area may be configured to set conditions such that the 2-4th area displays only vehicles that provide lines in a particular region. For example, the 2-5th area may be configured to set conditions such that the 2-4th area displays only affiliated vehicles of a particular seat type.

In an embodiment, the 2-5th area may include an object with which the user may interact. For example, one or more objects included in the 2-5th area may be icons, drop-down buttons, dialog boxes, and the like for setting conditions.

In an embodiment, the user using the third corporation management interface 700 may interact with an object included in the 2-5th area to deliver an input for setting vehicle listing conditions. In an embodiment, in response to receiving the input for setting the vehicle listing conditions, the processor may select data about one or more affiliated vehicles that satisfy the vehicle listing conditions, from among pieces of data about affiliated vehicles of a corporation. In an embodiment, the processor may load data about the selected one or more affiliated vehicles and display the data to be listed in the 2-4th area.

Meanwhile, although it is described above with reference to FIG. 7, for convenience of description, that the 2-1st area 710, the 2-2nd area 720, and the 2-3rd area 730 are displayed in one interface, and other areas or sub-interfaces are also displayed in one interface, the areas or sub-interfaces may be displayed in different interfaces.

Interface display switching between the interfaces included in the interface for managing a vehicle operating corporation described above, for example, the first corporation management interface, the second corporation management interface, or the third corporation management interface, may be performed in any suitable manner. For example, in a case in which, in response to receiving an input for interacting with an object included in the 1-3rd area, the second corporation management interface is to be displayed while the first corporation management interface is displayed, the second corporation management interface may be displayed as a pop-up interface on the first corporation management interface, or may be displayed to completely replace the first corporation management interface.

As described above, data about a corporation includes data about affiliated drivers belonging to the corporation. That is, in addition to information about a vehicle operating corporation that provides a demand-responsive transportation service, data about affiliated drivers may be registered in the control server. The control server may be configured to register an affiliated driver and manage a plurality of affiliated drivers. Registering an affiliated driver and managing a plurality of affiliated drivers may be performed through an interface for managing an affiliated driver according to the present disclosure.

The interface for managing an affiliated driver may be configured and provided to facilitate various functions and data processing for a user to register and manage an affiliated driver for a demand-responsive transportation service.

In an embodiment, the interface for managing an affiliated driver may be provided to a user terminal. In an embodiment, the user terminal may be the user terminal 310 described above.

The interface for managing an affiliated driver that may be provided to the user terminal may include one or more interfaces.

In an embodiment, a user who wants to manage an affiliated driver through the interface for managing an affiliated driver may log in to obtain an access permission. In an embodiment, the processor may permit the access and display a first driver management interface. The first driver management interface may be an interface that the user first encounters after logging in, among one or more interfaces that may be included in the interface for managing an affiliated driver, and may be configured to inquire or manage information about one or more affiliated drivers.

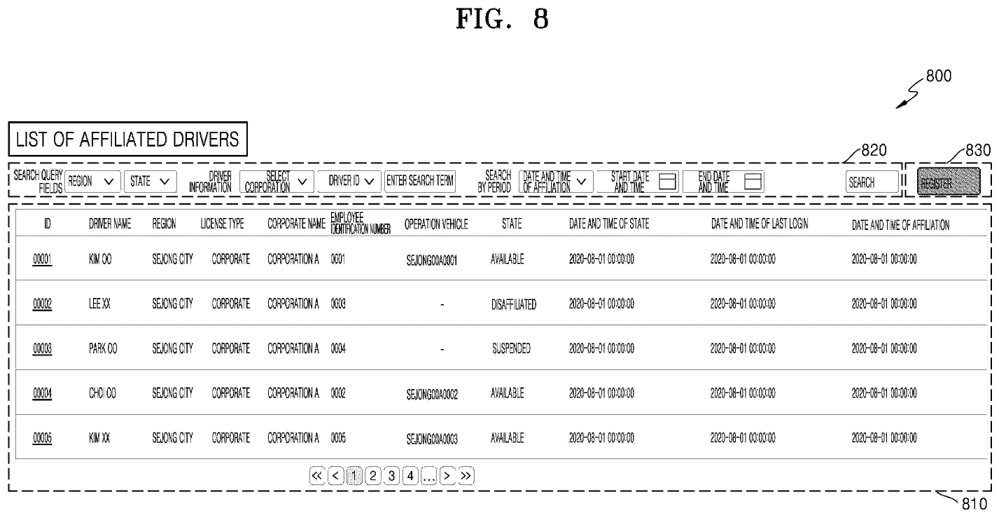

FIG. 8 is an exemplary diagram for describing a first driver management interface according to an embodiment.

Referring to FIG. 8, a first driver management interface 800 may include a 3-1st area 810, a 3-2nd area 820, and a 3-3rd area 830.

In an embodiment, the 3-1st area 810 that may be included in the first driver management interface 800 may be configured to list data about affiliated drivers registered in a corporation.

In an embodiment, the 3-1st area 810 may be configured as a list for checking various pieces of information about a driver, such as a driver ID, a driver name, a work region, a license type, the name of the corporation to which the driver belongs, an employee identification number, a vehicle operated by the driver, a current state, and the like. Although FIG. 8 illustrates that five affiliated drivers are listed in the 3-1 st area 810, but the present disclosure is not limited thereto.

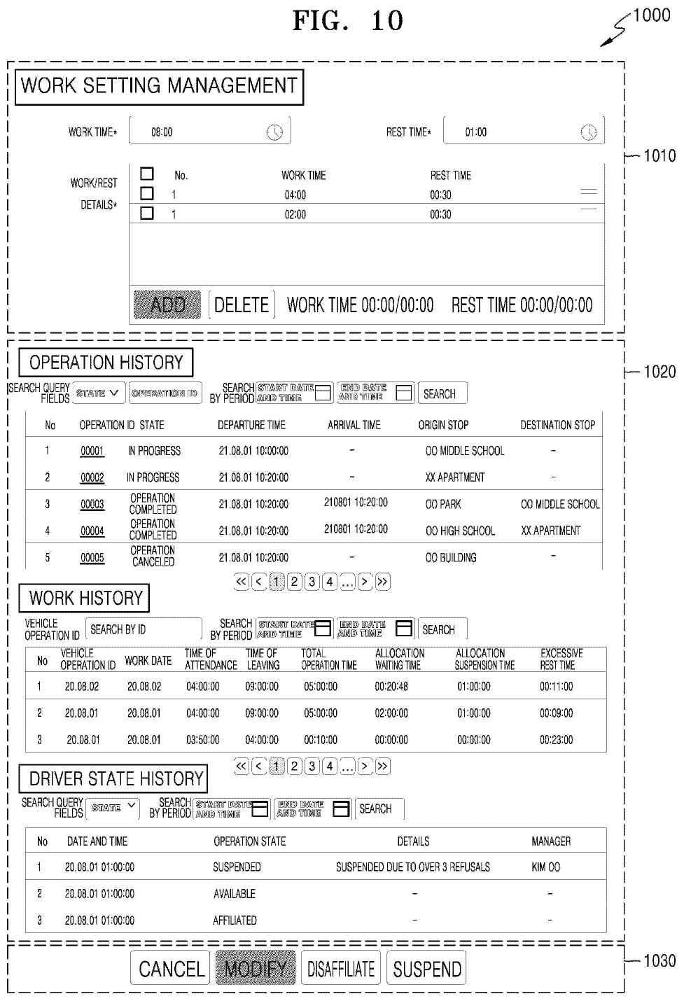

In an embodiment, the user using the first driver management interface 800 may interact with an object indicating a driver ID of a particular driver among the one or more affiliated drivers listed in the 3-1st area 810. In an embodiment, in response to receiving an input for interacting with an object indicating the driver ID of a particular driver, the processor may display a third driver management interface. An embodiment of the third driver management interface will be described in detail below with reference to FIG. 10.

In an embodiment, the 3-2nd area 820, which may be included in the first driver management interface 800, may be configured to set conditions for one or more affiliated drivers to be listed in the 3-1st area 810.

For example, the 3-2nd area 820 may be configured to set conditions such that the 3-1st area 810 displays only drivers who operate vehicles in a particular region. For example, the 3-2nd area 820 may be configured to set conditions such that the 3-1st area 810 displays only affiliated drivers having a particular license. In addition, the 3-2nd area 820 may be configured to have any suitable function such that the manager may selectively check information about an affiliated driver.

In an embodiment, the 3-2nd area 820 may include an object with which the user may interact. For example, one or more objects included in the 3-2nd area 820 may be icons, drop-down buttons, dialog boxes, and the like for setting conditions.

In an embodiment, the user using the first driver management interface 800 may interact with an object included in the 3-2nd area 820 to deliver an input for setting driver listing conditions. In an embodiment, in response to receiving the input for setting the driver listing conditions, the processor may select data about one or more affiliated drivers who satisfy the driver listing conditions, from among pieces of data about a plurality of affiliated drivers belonging to a corporation. In an embodiment, the processor may load data about one or more selected affiliated drivers, and display the data to be listed in the 3-1st area 810.

In an embodiment, in a case in which the user using the first driver management interface 800 has not set conditions through the 3-2nd area 820, data about one or more affiliated drivers listed in the 3-1st area 810 may be data about all registered affiliated drivers.

In an embodiment, the 3-3rd area 830, which may be included in the first driver management interface 800, may be configured to add data about an affiliated driver to the database.

In other words, the user using the interface for managing an affiliated driver may register a new driver through the 3-3rd area 830.

In an embodiment, the 3-3rd area 830 may include an object with which the user may interact. For example, one or more objects included in the 3-3rd area 830 may be icons.

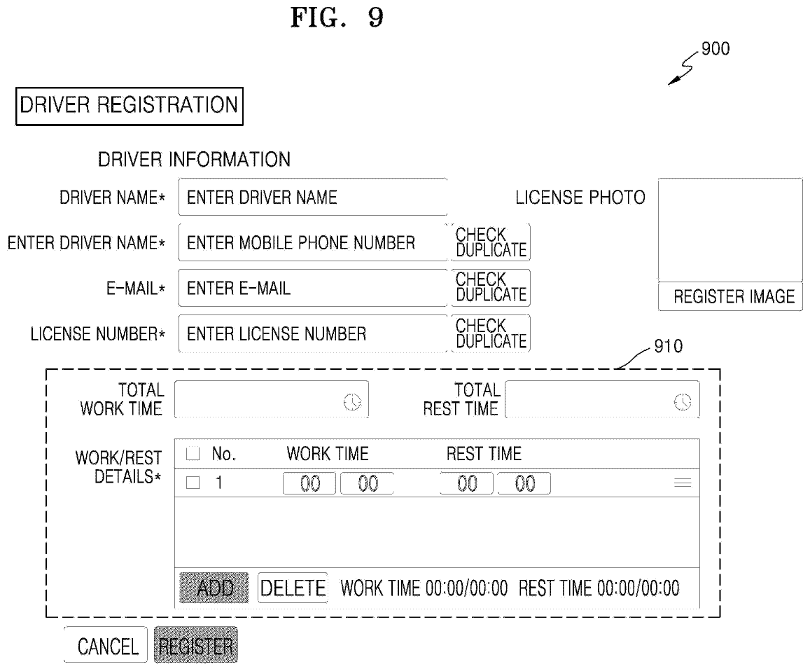

In an embodiment, the user using the interface for managing an affiliated driver may interact with an object included in the 3-3rd area 830, and in response to receiving an input for interacting with the object included in the 3-3rd area 830, the processor may display a second driver management interface. In the present disclosure, the second driver management interface may refer to an interface configured to add an affiliated driver to the database. An embodiment of the second driver management interface will be described in detail below with reference to FIG. 9.

In an embodiment, the first driver management interface 800 may further include a 3-4th area (not shown) configured to extract data about an affiliated driver as a file.

In an embodiment, the user using the driver management interface may interact with an object included in the 3-4th area, and in response to receiving an input for interacting with the object included in the 3-4th area, the processor may transmit data about one or more affiliated drivers as a file. In an embodiment, the data about the one or more affiliated drivers transmitted as the file may be data about drivers listed in the 3-1st area 810. In an embodiment, the 3-4th area may further include an object configured to receive data about all registered drivers as a file, in addition to data about the drivers listed in the 3-1st area 810.

In an embodiment, the user using the driver management interface may store or extract the transmitted file, to a storage device.

As described above, in response to receiving an input for interacting with an object included in the 3-3rd area 830, the processor may display the second driver management interface. The second driver management interface may be configured to add an affiliated driver to the database.

Meanwhile, although it is described above with reference to FIG. 8, for convenience of description, that the 3-1st area 810, the 3-2nd area 820, and the 3-3rd area 830 are displayed in one interface, and other areas or sub-interfaces are also displayed in one interface, the areas or sub-interfaces may be displayed in different interfaces.

FIG. 9 is an exemplary diagram for describing a second driver management interface according to an embodiment.

Referring to FIG. 9, a second driver management interface 900 may include an interface for inputting data about an affiliated driver.

In an embodiment, data about an affiliated driver that may be input through the second driver management interface 900 may include a driver name, contact information, an e-mail address, a license number, a photo, license information, a work setting, and the like.

In an embodiment, an interface for inputting each data about an affiliated driver may be suitably configured according to the type of the data about the affiliated driver. For example, an interface for inputting a driver name may be configured to receive a text input. For example, an interface for inputting contact information may be configured to receive a number input.

In an embodiment, the second driver management interface 900 may include a work setting interface 910 for inputting work setting data of an affiliated driver.

In an embodiment, the work setting data may include a total work time, a total rest time, a detailed work plan, or a detailed rest plan.

In an embodiment, the user using the second driver management interface 900 may input a total work time and a total rest time, through the work setting interface 910. In the present disclosure, the total work time may refer to a total time period during which the driver is scheduled to work on one workday, and the total rest time may refer to a total time period during which the driver is scheduled to rest on one workday.

In an embodiment, the user using the second driver management interface 900 may input one or more detailed work plans and one or more detailed rest plans, through the work setting interface. In the present disclosure, the detailed work plan may refer to a plan for continuous work times obtained by arbitrarily dividing the total work time, and the detailed rest plan may refer to a plan for continuous rest times obtained by arbitrarily dividing the total rest time. For example, the user using the second driver management interface 900 may determine a detailed work plan and a detailed rest plan according to a plan suitable for operating a demand-responsive vehicle, in accordance with other corporate policies or in consultation with the driver, and input the determined detailed work plan and detailed rest plan. As another example, the processor may calculate an exemplary detailed work plan and detailed rest plan, based on the detailed work plan and detailed rest plan of another driver belonging to the same corporation, for example, such that the overlapping work times are minimized, and display, on an interface, the calculated detailed work plan and detailed rest plan, for recommendation. As another example, the processor may display, on an interface, a detailed work plan and a detailed rest plan that are preset according to the input total work time, for recommendation.

In an embodiment, the processor may receive an input of a total work time and a total rest time. In an embodiment, the processor may receive an input of one or more detailed work plans and one or more detailed rest plans. In an embodiment, the processor may verify that the sum of work times included in the one or more detailed work plans is equal to the total work time, and verify that the sum of rest times included in the one or more detailed rest plans is equal to the total rest time.

In an embodiment, the user using the second driver management interface 900 may interact with a data input completion object that may be included in the second driver management interface 900, to complete input of data about a driver. In an embodiment, in a case in which minimum required data (e.g., driver name) for driver registration has not been input, even when the user interacts with the data input completion object, the input of the data about the driver may not be completed. In an embodiment, in response to the user interacting with the data input completion object, the processor may store the input data in the database.

Meanwhile, although it is described above with reference to FIG. 9, for convenience of description, that areas or sub-interfaces are displayed in one interface, the areas or sub-interfaces may be displayed in different interfaces.

As described above, in an embodiment, in response to receiving an input for interacting with an object indicating the driver ID of a particular driver, the processor may display the third driver management interface. In the present disclosure, the third driver management interface may refer to an interface for checking detailed information about a particular driver.

FIG. 10 is an exemplary diagram for describing a third driver management interface according to an embodiment.

Referring to FIG. 10, a third driver management interface 1000 may include a 4-1st area 1010, a 4-2nd area 1020, and a 4-3rd area 1030.

In an embodiment, the 4-1st area 1010 that may be included in the third driver management interface 1000 may be configured to display work setting data of a particular driver, and modify or delete the work setting data. In the present embodiment, the work setting data may correspond to the work setting data described above with reference to FIG. 9. Thus, the embodiments of work setting data described in detail above with reference to FIG. 9 may be equally applied to a process of modifying or deleting work setting data through the third driver management interface 1000.

In an embodiment, the 4-2nd area 1020, which may be included in the third driver management interface 1000, may be configured to display an operation history, a work history, and a driver state history of a particular driver. The operation history, work history, and driver state history of the particular driver, which may be included in the 4-2nd area 1020, may be updated in real time.

In an embodiment, the operation history may refer to data about a history of operating a vehicle by the particular driver. In an embodiment, the operation history may be data that is automatically recorded in a server according to an operation of a demand-responsive vehicle included in the demand-responsive transportation system. In another embodiment, the operation history may be data that is manually input and recorded in the server when a driver operating a demand-responsive vehicle starts or ends an operation of the demand-responsive vehicle.

In an embodiment, the work history may refer to data about a work history of a particular driver. In an embodiment, the work history may include a work date, a time of attendance, a time of leaving, a rest time, a vehicle operation time, and the like. In an embodiment, the time of attendance or the time of leaving may be a time point at which a particular driver attends or leaves a workplace. In another embodiment, the time of attendance or the time of leaving may be a time point at which a particular driver first starts an operation or last ends the operation on a work day, in which case, the time of attendance or the time of leaving may be automatically recorded in the server according to the operation of the demand-responsive vehicle. In an embodiment, the work history may be data that is the basis of an automatic management function for a particular driver to be described below.

In an embodiment, the driver state history may refer to data about an affiliation history, an operation permission history, a warning history, a suspension history, a disaffiliation history, and the like of a particular driver. In an embodiment, the driver state history may be data that is the basis of a disaffiliation process or a suspension management function to be described below. In an embodiment, the driver state history may be data that is automatically recorded in the server when the user registers an affiliated driver through the second driver management interface 900 or uses the disaffiliation process or the suspension management function to be described below, through the third driver management interface 1000.

In an embodiment, the 4-3rd area 1030 that may be included in the third driver management interface 1000 may be configured to modify data about a particular driver, or perform disaffiliation or suspension management on a particular driver.

In an embodiment, the 4-3rd area 1030 may include an object with which the user may interact. In an embodiment, one or more objects included in the 4-3rd area 1030 may include an object for modifying data about a particular driver, an object for performing disaffiliation on a particular driver, or an object for performing suspension management on a particular driver.

In an embodiment, the user using the third driver management interface 1000 may interact with the object for modifying data about a particular driver included in the 4-3rd area 1030, and in response to receiving an interaction with the object for modifying data about a particular driver, the processor may display an interface for modifying the data about the particular driver. In an embodiment, the user using the third driver management interface 1000 may input, through the displayed interface, a signal for modifying the data about the particular driver. In an embodiment, in response to an input of the user for modifying data, the processor may modify the data about the particular driver included in the database.

In an embodiment, in response to receiving a disaffiliation process request signal transmitted based on an interaction with an object included in the 4-3rd area 1030, the processor may display an interface for processing disaffiliation of a particular driver, and receive an input regarding a reason for the disaffiliation.

In detail, in an embodiment, the user using the third driver management interface 1000 may interact with an object for processing disaffiliation of a particular driver included in the 4-3rd area 1030, and in response to receiving an interaction with the object for processing the disaffiliation of the particular driver, the processor may display an interface for processing the disaffiliation of the particular driver.

In an embodiment, the interface for processing disaffiliation of a particular driver may include an interface for inputting a reason for disaffiliation. In an embodiment, the user who wants to perform disaffiliation of a particular driver may input a reason for the disaffiliation, through the interface. In an embodiment, the reason for disaffiliation may be input by selecting any one of a plurality of predefined reasons for disaffiliation. In an embodiment, in response to a reason for disaffiliation being input, the processor may receive an input of the reason for disaffiliation and store the input in the database. In an embodiment, in response to receiving an input of a reason for disaffiliation, the processor may delete data about a particular driver from the database. In another embodiment, in response to receiving an input of a reason for disaffiliation, the processor may move data about a particular driver to a database for temporary storage, and when a preset time period (e.g., 3 days, 5 days, 2 weeks, etc.) elapses, automatically delete the data from the database for temporary storage.

In an embodiment, in response to receiving a suspension management request signal transmitted based on an interaction with an object included in the 4-3rd area, the processor may, when a particular driver is currently suspended, display a suspension release interface for the particular driver, and when the particular driver is not currently suspended, display a suspension registration interface for the particular driver. In an embodiment, displaying the suspension registration interface by the processor may include displaying data about the particular driver and receiving an input of a suspension period and a reason for suspension.

In detail, in an embodiment, the user using the third driver management interface 1000 may interact with an object for performing suspension management on a particular driver included in the 4-3rd area 1030, and in response to receiving an interaction with the object for performing suspension management on the particular driver, the processor may display an interface for performing suspension management on the particular driver.

In an embodiment, when the particular driver is currently suspended, the interface for performing suspension management displayed by the processor may be a suspension release interface. In an embodiment, the user who wants to perform a suspension release process may input a suspension release signal by interacting with an object included in the suspension release interface. In an embodiment, in response to receiving an input of the suspension release signal, the processor may modify the driver state history of the particular driver in the database.

In an embodiment, when the particular driver is not currently suspended, the interface for performing suspension management displayed by the processor may be a suspension registration interface. In an embodiment, the suspension registration interface displayed by the processor may include an area for displaying data about the particular driver, an area for inputting a suspension period, and an area for inputting a reason for suspension. For example, the data about the particular driver displayed in the suspension registration interface may include a driver name, a driver ID, contact information, and the like, and erroneous suspension may be prevented through such a reconfirmation process. In an embodiment, the user who wants to register suspension of a particular driver may input a suspension period and a reason for suspension through the suspension registration interface, and in response to receiving an input of the suspension period and the reason for suspension, the processor may modify data about the particular driver and the driver state history in the database.

As described above, the user using the first driver management interface 800 may interact with an object indicating a driver ID of a particular driver among the one or more affiliated drivers listed in the 3-1st area 810. In an embodiment, in response to receiving an input for interacting with the object indicating the driver ID of the particular driver, the processor may perform an automatic management function on the particular driver.

In an embodiment, the automatic management function may refer to a function of classifying a particular driver into a group, based on data about the particular driver, and providing a notification based on the group into which the particular driver is classified.

In an embodiment, the processor may determine an abnormal work history based on data about a particular driver, specifically, work setting data, an operation history, and a work history.

In the present disclosure, the abnormal work history is a measure of whether the particular driver is performing his/her work in accordance with regulations, and any suitable method may be applied to express the abnormal work history. For example, the abnormal work history may be expressed as a positive integer greater than or equal to 0. For example, when the number of late arrivals at work of the particular driver reaches a preset value, the abnormal work history may be increased by 1. For example, when the cumulative value of rest times of the particular driver exceeds the rest time set in the work setting data and reaches a preset value, the abnormal work history may be increased by 1. For example, when the number of refusals to allocation of the particular driver reaches a preset value, the abnormal work history may be increased by 1. For example, a point may be given to an abnormal work event, such as late arrival at work, excessive rest, or refusal to allocation, and the abnormal work points of the driver may be accumulated upon an abnormal work event occurring, and when the abnormal work points of the particular driver reach a preset value, the abnormal work history may be increased by 1.

In an embodiment, the processor may classify a particular driver into a group, based on the determined abnormal work history of the particular driver. For example, the particular driver may be classified into any one of a normal group, a warning group, and a suspension group, according to the value of the abnormal work history of the particular driver. In the present disclosure, the normal group may refer to a state in which there is no or acceptable abnormal work events, the warning group may refer to a state in which abnormal work events have been accumulated to a certain extent and management is thus required, and the suspension group may refer to a state in which abnormal work events have been sufficiently accumulated and suspension is thus required.

In an embodiment, the processor may, in response to the particular driver being classified into the suspension group, display a warning message, and in response to the particular driver being classified into the warning group and the particular driver not being currently suspended, display a suspension message.

In detail, in an embodiment, in response to the particular driver being classified into the warning group, the processor may display the warning message. For example, the warning message may include a phrase for notifying the user checking the displayed warning message, that the driver needs to be managed, such as “There is a risk of suspension” or “Driver management is required”.

In an embodiment, in response to the particular driver being classified into the suspension group and the particular driver not being currently suspended, the processor may display the suspension message. For example, the suspension message may include a phrase for notifying the user checking the displayed suspension message, that the driver needs to be suspended, such as “Suspension is required” or “There is a reason for suspension”. In another embodiment, the processor may change the current state of the particular driver to ‘Suspended’, instead of displaying the suspension message.

In an embodiment, the processor may display the suspension message by displaying a suspension registration interface for the particular driver. The suspension registration interface may be the same as the suspension registration interface described above, and thus, the embodiment of the suspension registration interface described above may be equally applied.

In other words, displaying the suspension message by the processor may includes displaying the suspension registration interface for the particular driver, which may include displaying data about the particular driver and receiving an input of a suspension period and a reason for suspension.

In response to the processor receiving an input for interacting with an object indicating the driver ID of the particular driver, the embodiment related to the automatic management function described above may be performed before or simultaneously with the displaying of the third driver management interface 1000. For example, the processor may display the third driver management interface 1000, and then display the suspension registration interface in the form of a pop-up.

Interface display switching between the interfaces included in the interface for managing an affiliated driver described above, for example, the first driver management interface, the second driver management interface, or the third driver management interface, may be performed in any suitable manner. For example, in a case in which, in response to receiving an input for interacting with an object included in the 3-3rd area, the second driver management interface is to be displayed while the first driver management interface is displayed, the second driver management interface may be displayed as a pop-up interface on the first driver management interface, or may be displayed to completely replace the first driver management interface.

Those of skill in the art of the present disclosure will easily understand that elements added to the names of the respective areas or interfaces (e.g., ‘1-1st area’, ‘first corporation management interface’, etc.) are for convenience of description.

The above-described interface for managing a vehicle operating corporation and interface for managing an affiliated driver belonging to a vehicle operating corporation may be provided to be linked to each other and switched to the other according to a method in which the interface providing device configures the interfaces. For example, the first corporation management interface may include a certain object with which the user of the interface may interact, and in response to receiving an input of the user for interacting with the object, the processor may provide the interface for managing an affiliated driver including the first driver management interface. Conversely, the first driver management interface may include a certain object with which the user of the interface may interact, and in response to receiving an input of the user for interacting with the object, the processor may provide the interface for managing a corporation including the first corporation management interface.

A user terminal included in the demand-responsive transportation system may receive an interface according to various embodiments of the present disclosure, which may be performed by the processor included in the interface providing device, and allow the user to interact with the interface or an object included in the interface.

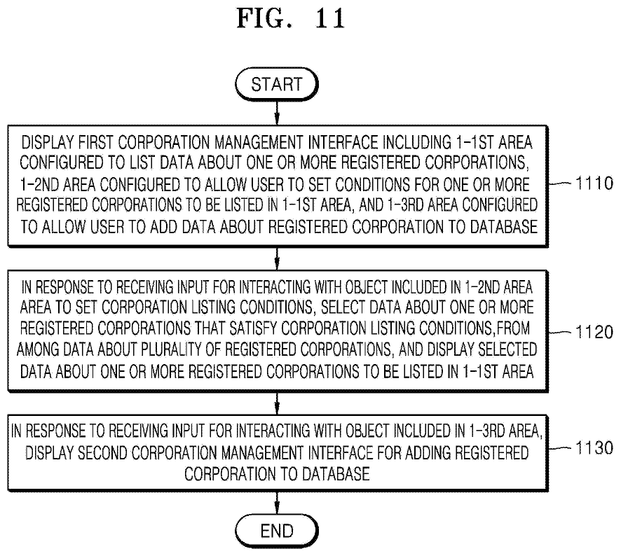

FIG. 11 is a flowchart of a method of providing an interface for managing a vehicle operating corporation according to an embodiment.

The method of providing the interface for managing a vehicle operating corporation illustrated in FIG. 11 is related to the above-described embodiments, and thus, the descriptions of the embodiments provided above, even omitted below, may also be applied to the method of FIG. 11.

The operations illustrated in FIG. 11 may be performed by the interface providing device described above. In detail, the operations illustrated in FIG. 11 may be performed by a processor included in the interface providing device described above.

In operation 1110, the processor may display a first corporation management interface including a 1-1st area configured to list data about one or more registered corporations, a 1-2nd area configured to set conditions for one or more registered corporations to be listed in the 1-1st area, and a 1-3rd area configured to add data about a registered corporation to a database.

In operation 1120, in response to receiving an input for interacting with an object included in the 1-2nd area to set corporation listing conditions, the processor may select data about one or more registered corporations that satisfy the corporation listing conditions, from among data about a plurality of registered corporations, and display the selected data about the one or more registered corporations to be listed in the 1-1st area.

In operation 1130, in response to receiving an input for interacting with an object included in the 1-3rd area, the processor may display a second corporation management interface for adding a registered corporation to the database.

In an embodiment, the processor may display an interface for inputting data about a registered corporation including an operation provision region and a vehicle-type product, in response to receiving an input of an operation provision region, determine one or more vehicle-type products that may be provided in the input operation provision region, and display the second corporation management interface by displaying the determined one or more vehicle-type products such that any one of the determined one or more vehicle-type products is selected.

In an embodiment, after operation 1130, in response to receiving an input for interacting with an object indicating a corporation ID of a particular corporation among the one or more registered corporations listed in the 1-1st area, the processor may display a third corporation management interface including a 2-1 st area configured to display data about the particular corporation and modify or delete the data about the particular corporation, a 2-2nd area configured to list data about one or more affiliated drivers belonging to the particular corporation, and a 2-3rd area configured to set conditions for one or more affiliated drivers to be listed in the 2-2nd area, and in response to receiving an input for interacting with an object included in the 2-3rd area to set driver listing conditions, load data about one or more affiliated drivers who satisfy the driver listing conditions from the database, and display the loaded data about the one or more affiliated drivers to be listed in the 2-2nd area.

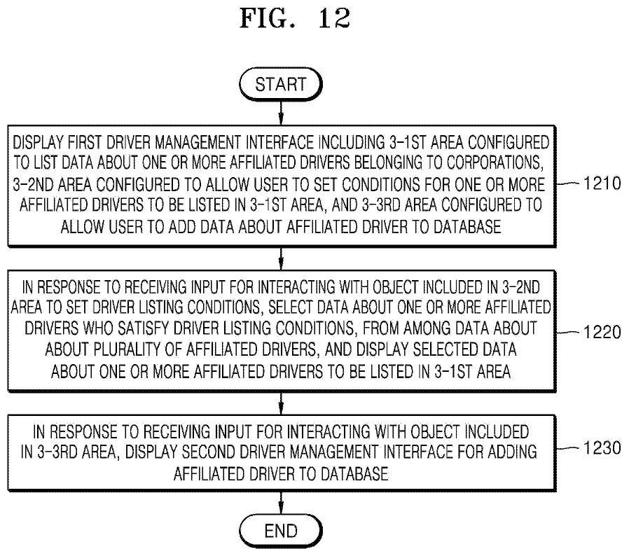

FIG. 12 is a flowchart of a method of providing an interface for managing an affiliated driver belonging to a vehicle operating corporation according to an embodiment.

The method of providing the interface for managing an affiliated driver belonging to a vehicle operating corporation illustrated in FIG. 12 is related to the above-described embodiments, and thus, the descriptions of the embodiments provided above, even omitted below, may also be applied to the method of FIG. 12.

The operations illustrated in FIG. 12 may be performed by the interface providing device described above. In detail, the operations illustrated in FIG. 12 may be performed by the processor included in the interface providing device described above.

In operation 1210, the processor may display a first driver management interface including a 3-1 st area configured to list data about one or more affiliated drivers belonging to corporations, a 3-2nd area configured to set conditions for one or more affiliated drivers to be listed in the 3-1st area, and a 3-3rd area configured to add data about an affiliated driver to a database.

In operation 1220, in response to receiving an input for interacting with an object included in the 3-2nd area to set driver listing conditions, the processor may select data about one or more affiliated drivers who satisfy the driver listing conditions, from among data about a plurality of affiliated drivers, and display the selected data about the one or more affiliated drivers to be listed in the 3-1 st area.

In operation 1230, in response to receiving an input for interacting with an object included in the 3-3rd area, the processor may display a second driver management interface for adding an affiliated driver to the database.

In an embodiment, the processor may display the second driver management interface by displaying an interface for inputting data about the affiliated driver including driver information, license information, and a work schedule, and after operation 1230, receive an input of data about the affiliated driver.

In an embodiment, the processor may display the second driver management interface by displaying an interface for inputting work setting data of the affiliated driver, and after operation 1230, receive an input of a total work time and a total rest time included in the work setting data, receive an input of one or more detailed work plans and one or more detailed rest plans included in the work setting data, verify whether the sum of work times included in the one or more detailed work plans is equal to the total work time, and verify whether the sum of rest times included in the one or more detailed rest plans is equal to the total rest time.

In an embodiment, after operation 1230, in response to receiving an input for interacting with an object indicating a driver ID of a particular driver among the one or more affiliated drivers listed in the 3-1st area, the processor may display a third driver management interface including a 4-1st area configured to display work setting data of the particular driver and modify or delete the work setting data, a 4-2nd area configured to display an operation history, a work history, and a driver state history of the particular driver, and a 4-3rd area configured to modify data about the particular driver or perform a disaffiliation process or suspension management on the particular driver.

In an embodiment, after operation 1230, in response to receiving an input for interacting with an object indicating a driver ID of a particular driver among the one or more affiliated drivers listed in the 3-1st region, the processor may determine an abnormal work history of the particular driver based on the work setting data, the operation history, and the work history included in the data about the particular driver, and classify the particular driver into any one of a normal group, a warning group, and a suspension group, based on the abnormal work history.

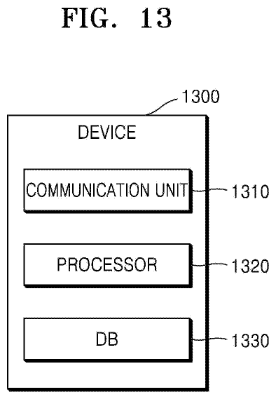

FIG. 13 is a block diagram of an interface providing device according to an embodiment.

Referring to FIG. 13, an interface providing device 1300 may include a communication unit 1310, a processor 1320, and a database (DB) 1330. FIG. 13 illustrates the interface providing device 1300 including only components related to an embodiment. Therefore, it would be understood by those of skill in the art that other general-purpose components may be further included in addition to those illustrated in FIG. 13.

The communication unit 1310 may include one or more components for performing wired/wireless communication with an external server or an external device. For example, the communication unit 1310 may include at least one of a short-range communication unit (not shown), a mobile communication unit (not shown), and a broadcast receiver (not shown).

The DB 1330 is hardware for storing various pieces of data processed by the interface providing device 1300, and may store a program for the processor 1320 to perform processing and control. The DB 1330 may store payment information, user information, and the like.

The DB 1330 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 1320 controls the overall operation of the interface providing device 1300. For example, the processor 1320 may execute programs stored in the DB 1330 to control the overall operation of an input unit (not shown), a display (not shown), the communication unit 1310, the DB 1330, and the like. The processor 1320 may execute programs stored in the DB 1330 to control the operation of the interface providing device 1300.

The processor 1320 may control at least some of the operations of the interface providing device 1300 described above with reference to FIGS. 1 to 12.

The processor 1320 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

In an embodiment, the interface providing device 1300 may be a mobile electronic device. For example, the interface providing device 1300 may be implemented as a smart phone, a tablet personal computer (PC), a PC, a smart television (TV), a personal digital assistant (PDA), a laptop computer, a media player, a navigation system, a camera-equipped device, and other mobile electronic devices. In addition, the interface providing device 1300 may be implemented as a wearable device having a communication function and a data processing function, such as a watch, glasses, a hair band, a ring, or the like.

In another embodiment, the interface providing device 1300 may be an electronic device embedded in a vehicle. For example, the interface providing device 1300 may be an electronic device that is manufactured and then inserted into a vehicle through tuning.

In another embodiment, the interface providing device 1300 may be a server located outside a vehicle. The server may be implemented as a computer device or a plurality of computer devices that provide a command, code, a file, content, a service, and the like by performing communication through a network. The server may receive data necessary for determining a moving path of the vehicle from devices mounted on the vehicle, and determine the moving path of the vehicle based on the received data.

In another embodiment, a process performed by the interface providing device 1300 may be performed by at least some of a mobile electronic device, an electronic device embedded in the vehicle, and a server located outside the vehicle.

Embodiments of the present disclosure may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

Meanwhile, the computer program may be specially designed and configured for the present disclosure or may be well-known to and usable by those skill in the art of computer software. Examples of the computer program may include not only machine code, such as code made by a compiler, but also high-level language code that is executable by a computer by using an interpreter or the like.

According to an embodiment, the method according to various embodiments of the present disclosure may be included in a computer program product and provided. The computer program products may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

The operations of the methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. In addition, various modifications, combinations, and adaptations will be readily apparent to those skill in the art without departing from the following claims and equivalents thereof.

Accordingly, the spirit of the present disclosure should not be limited to the above-described embodiments, and all modifications and variations which may be derived from the meanings, scopes and equivalents of the claims should be construed as failing within the scope of the present disclosure.

According to the present disclosure, there may be provided an interface for allowing a manager who wants to manage a vehicle operating corporation that operates demand-responsive vehicles, to effectively perform the management.

In addition, there may be provided an interface for allowing a manager who wants to manage a driver belonging to a vehicle operating corporation that operates demand-responsive vehicles, to effectively perform the management.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of providing an interface for managing a vehicle operating corporation, the method comprising:
displaying a first corporation management interface comprising a 1-1st area configured to list data about one or more registered corporations, a 1-2nd area configured to set conditions for the one or more registered corporations to be listed in the 1-1st area, and a 1-3rd area configured to add data about a registered corporation to a database;
in response to receiving an input for interacting with an object included in the 1-2nd area to set corporation listing conditions, selecting data about one or more registered corporations that satisfy the corporation listing conditions, from among data about a plurality of registered corporations, and displaying the selected data about the one or more registered corporations to be listed in the 1-1st area; and
in response to receiving an input for interacting with an object included in the 1-3rd area, displaying a second corporation management interface for adding a registered corporation to the database.

2. The method of claim 1, wherein the displaying of the second corporation management interface comprises:
displaying an interface for inputting data about the registered corporation, the data comprising an operation provision region and a vehicle-type product;
in response to receiving an input of the operation provision region, determining one or more vehicle-type products that are providable in the input operation provision region; and
displaying the determined one or more vehicle-type products such that any one of the determined one or more vehicle-type products is selected.

3. The method of claim 1, further comprising:
in response to receiving an input for interacting with an object indicating a corporation identifier (ID) of a particular corporation among the one or more registered corporations listed in the 1-1st area, displaying a third corporation management interface comprising a 2-1st area configured to display data about the particular corporation and modify or delete the data about the particular corporation, a 2-2nd area configured to list data about one or more affiliated drivers belonging to the particular corporation, and a 2-3rd area configured to set conditions for the one or more affiliated drivers to be listed in the 2-2nd area; and
in response to receiving an input for interacting with an object included in the 2-3rd area to set driver listing conditions, loading data about one or more affiliated drivers who satisfy the driver listing conditions from the database, and displaying the loaded data about the one or more affiliated drivers to be listed in the 2-2nd area.

4. A method of providing an interface for managing an affiliated driver belonging to a vehicle operating corporation, the method comprising:
displaying a first driver management interface comprising a 3-1st area configured to list data about one or more affiliated drivers belonging to a corporation, a 3-2nd area configured to set conditions for the one or more affiliated drivers to be listed in the 3-1 st area, and a 3-3rd area configured to add data about an affiliated driver to a database;
in response to receiving an input for interacting with an object included in the 3-2nd area to set driver listing conditions, selecting data about one or more affiliated drivers who satisfy the driver listing conditions, from among data about a plurality of affiliated drivers, and displaying the selected data about the one or more affiliated drivers to be listed in the 3-1 st area; and
in response to receiving an input for interacting with an object included in the 3-3rd area, displaying a second driver management interface for adding an affiliated driver to the database.

5. The method of claim 4, wherein the displaying of the second driver management interface comprises displaying an interface for inputting data about an affiliated driver, the data comprising driver information, license information, and a work schedule, and
the method further comprises receiving an input of data about the affiliated driver.

6. The method of claim 4, wherein the displaying of the second driver management interface comprises displaying an interface for inputting work setting data of the affiliated driver, and
the method further comprises:
receiving an input of a total work time and a total rest time included in the work setting data;
receiving an input of one or more detailed work plans and one or more detailed rest plans included in the work setting data; and
verifying whether a sum of work times included in the one or more detailed work plans is equal to the total work time, and verifying whether a sum of rest times included in the one or more detailed rest plans is equal to the total rest time.

7. The method of claim 4, further comprising, in response to receiving an input for interacting with an object indicating a driver identifier (ID) of a particular driver among the one or more affiliated drivers listed in the 3-1 st area, displaying a third driver management interface comprising a 4-1st area configured to display work setting data of the particular driver and modify or delete the work setting data, a 4-2nd area configured to display an operation history, a work history, and a driver state history of the particular driver, and a 4-3rd area configured to modify data about the particular driver or perform a disaffiliation process or suspension management on the particular driver.

8. The method of claim 4, further comprising:
in response to receiving an input for interacting with an object indicating a driver ID of a particular driver among the one or more affiliated drivers listed in the 3-1 st area, determining an abnormal work history of the particular driver, based on work setting data, an operation history, and a work history included in data about the particular driver; and
classifying the particular driver into any one of a normal group, a warning group, and a suspension group, based on the abnormal work history.

9. A device for providing an interface for managing a vehicle operating corporation, the device comprising:
a memory storing at least one program; and
a processor configured to execute the at least one program to display a first corporation management interface comprising a 1-1st area configured to list data about one or more registered corporations, a 1-2nd area configured to set conditions for the one or more registered corporations to be listed in the 1-1st area, and a 1-3rd area configured to add data about a registered corporation to a database, in response to receiving an input for interacting with an object included in the 1-2nd area to set corporation listing conditions, select data about one or more registered corporations that satisfy the corporation listing conditions, from among data about a plurality of registered corporations, and display the selected data about the one or more registered corporations to be listed in the 1-1st area, and in response to receiving an input for interacting with an object included in the 1-3rd area, display a second corporation management interface for adding a registered corporation to the database.

10. A device for providing an interface for managing an affiliated driver belonging to a vehicle operating corporation, the device comprising:
a memory storing at least one program; and
a processor configured to execute the at least one program to display a first driver management interface comprising a 3-1st area configured to list data about one or more affiliated drivers belonging to a corporation, a 3-2nd area configured to set conditions for the one or more affiliated drivers to be listed in the 3-1st area, and a 3-3rd area configured to add data about an affiliated driver to a database, in response to receiving an input for interacting with an object included in the 3-2nd area to set driver listing conditions, select data about one or more affiliated drivers who satisfy the driver listing conditions, from among data about a plurality of affiliated drivers, and display the selected data about the one or more affiliated drivers to be listed in the 3-1st area, and in response to receiving an input for interacting with an object included in the 3-3rd area, display a second driver management interface for adding an affiliated driver to the database.

11. A computer-readable recording medium having recorded thereon a program for causing a computer to execute the method of claim 1.
